(19) United States
(12) Patent Application Publication
(10) Pub. No.: US 2025/0315288 A1
(43) Pub. Date: Oct. 9, 2025

(54) Dynamic Testing with Digital Engineering Virtual Interface Synchronization using Machine Learning

(71) Applicant: Science Applications International Corporation, Reston, VA (US)

(72) Inventor: Benjamin Colby Jones, Tuscumbia, AL (US)

(21) Appl. No.: 18/626,485

(22) Filed: Apr. 4, 2024

(51) Int. Cl. G06F 9/455; G06N 20/00

(52) U.S. Cl. CPC G06F 9/45558; G06N 20/00; G06F 2009/45591

(57) ABSTRACT

A digital engineering ecosystem may use artificial intelligence to generate a virtual hardware interface to emulate a hardware interface described in one or more hardware specifications. The virtual hardware interface may receive executable code configured to execute on the hardware interface. The virtual hardware interface may execute the received executable code, and, after being successfully executed, the execution of the executable code may be logged.

### BACKGROUND OF THE INVENTION

Current industry solutions for software development for new hardware typically require manual transformation and/or codification of hardware interfaces. These virtual hardware components must then be kept in sync with design changes manually. If changes occur in the hardware development lifecycle, the risk of each design getting out of sync with the corresponding virtual hardware components increases, for example, due to missed or misunderstood requirements.

### SUMMARY OF THE INVENTION

The following presents a simplified summary of various features described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

Aspects of the disclosure generally relate to automatically and/or dynamically generating virtual hardware interfaces to emulate a hardware interface being developed concurrently with software designed to execute on the hardware interface. Virtual hardware interfaces may be generated, for example, based on or in response to updates, changes, modifications, and/or alterations to hardware specifications for hardware interfaces. This allows the virtual hardware interfaces to be included as part of a development, security, and operations (DevSecOps) pipeline to improve software quality and realize efficiencies in both hardware and software development.

Aspects described herein may relate to training first artificial intelligence to generate one or more virtual hardware interfaces. Additional aspects described herein may relate to training second artificial intelligence to generate one or more scripts to test the one or more virtual hardware interfaces generated by the first artificial intelligence. A digital engineering ecosystem may allow developers to use the first artificial intelligence and the second artificial intelligence as part of their digital design work.

In operation, the digital engineering ecosystem may receive a request to generate a virtual hardware interface, for example, based on a hardware specification for the hardware interface and/or a code commit for the hardware interface. The first artificial intelligence may generate the virtual hardware interface to emulate the hardware interface described in the hardware specification. Once the virtual hardware interface is generated, the second artificial intelligence may generate one or more scripts to validate and/or verify that the virtual hardware interface performs (e.g., executes) in accordance with the hardware specification. When the one or more scripts are successfully executed by the virtual hardware interface, the virtual hardware interface may receive executable code. The executable code may be embedded software configured to execute on the hardware interface. The virtual hardware interface may execute the received executable code. When the executable code is executed successfully (e.g., performs as intended), the successful execution of the executable code may be logged.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 shows an example of a digital engineering ecosystem, including interactions between software and relationships of software to engineering project phases, in accordance with one or more aspects of the disclosure;

FIG. 2 shows an example network in which a digital engineering ecosystem may be implemented;

FIG. 3 shows an example of digital engineering ecosystem software hosted on a computing device in accordance with one or more aspects of the disclosure;

FIG. 4 shows an example process for training artificial intelligence in accordance with one or more aspects of the disclosure;

FIG. 5 shows an example process for executing code on a virtual hardware interface in accordance with one or more aspects of the disclosure;

FIG. 6 shows an example process for updating the virtual hardware interface in accordance with one or more aspects of the disclosure; and

FIG. 7 shows an example of a computing device in accordance with one or more aspects of the disclosure.

### DETAILED DESCRIPTION

In the following description, reference is made to the accompanying drawings, which form a part hereof, and in which are shown various examples of features of the disclosure and/or of how the disclosure may be practiced. It is to be understood that other features may be utilized and structural and functional modifications may be made without departing from the scope of the present disclosure. The disclosure may be practiced or carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, features discussed herein may relate to methods, devices, systems, and/or computer-readable media for automatically and/or dynamically generating virtual hardware interfaces, for example, based on or in response to updates, changes, modifications, and/or alterations to the hardware specifications associated with hardware being developed, built, or, otherwise, engineered. As used herein, virtual hardware interfaces refer to one or more abstract virtualized representations of hardware interface(s) that correspond to one or more hardware interfaces being developed, built, or, otherwise, engineered. Virtual hardware interfaces may comprise a hypervisor or virtual machine manager (VMM). The hypervisor or VMM may create an abstraction layer between software and underlying hardware. Once a hypervisor or VMM is in place, executable code may rely on virtual representations of the computing components associated with the hardware interface being developed, built, or, otherwise, engineered, such as virtual processors rather than physical processors. The virtual hardware interfaces may be included in a development, security, and operations (DevSecOps) pipeline, which may improve software quality and realize efficiencies in both hardware and software development. By using artificial intelligence, such as large language models, to generate virtual hardware interfaces, both hardware and software development may be verified and/or validated in response to changes, modifications, and/or alterations to the hardware design.

In order to generate virtual hardware interfaces, first artificial intelligence may be trained to generate one or more virtual hardware interfaces. In order to test the one or more virtual hardware interfaces generated by the first artificial intelligence, second artificial intelligence may be trained to generate one or more scripts to test the first artificial intelligence. Once the artificial intelligence is trained, both the first artificial intelligence and the second artificial intelligence may be deployed as part of a digital engineering ecosystem.

After being deployed, the digital engineering ecosystem may receive a request to generate a virtual hardware interface. The request may be based on, or in response to, receiving a hardware specification for the hardware interface. Additionally or alternatively, the request may be based on, or in response to, receiving a code commit for the hardware interface. The first artificial intelligence may generate the virtual hardware interface to emulate a hardware interface being developed concurrently with software designed to execute on the hardware interface. Once the virtual hardware interface is generated, the second artificial intelligence may generate one or more scripts. The one or more scripts may be designed to validate and/or verify that the virtual hardware interface performs (e.g., executes) in accordance with the specification for the hardware interface. In this regard, the one or more scripts may be executable code and/or embedded software that are executed to ensure that the system (e.g., virtual hardware interface) functions as expected. As will be explained in greater detail below, the one or more scripts may be configured to ensure that the virtual hardware interface executes within fixed hardware requirements and/or capabilities defined in the hardware specifications for the hardware interface corresponding to the virtual hardware interface. When the one or more scripts are not executed successfully, an alert may be generated indicating that the virtual hardware interface did not execute the one or more test scripts successfully. This may cause a redesign of the hardware interface and/or the virtual hardware interface. When the one or more scripts are successfully executed by the virtual hardware interface, the virtual hardware interface may receive executable code. The executable code may be embedded software configured to execute on the hardware interface. As used herein, “embedded software” means specialized programming configured to control specific functions, such as a microchip or other hardware component, of a device that is not a personal computer (PC). Embedded software has fixed hardware requirements and capabilities. Embedded software is created exclusively for a particular device (e.g., hardware interface) that it runs on, with processing and memory restrictions tied directly to that device's specifications. In the context of this disclosure, embedded software includes applications, firmware, middleware, and operating systems that execute on a single microprocessor or cluster of microprocessors “embedded” within additional logic. The virtual hardware interface may execute the received executable code. When the executable code is executed successfully (e.g., performs as intended), the successful execution of the executable code may be logged. However, when the executable code is not executed successfully, an alert may be generated. The alert may indicate that the virtual hardware interface did not execute the executable code successfully. Additionally or alternatively, the alert may indicate that the executable code did not execute on the virtual hardware interface successfully. Based on the alert, a redesign of the hardware interface, the executable code, or both may be required.

By allowing the hardware interface and the executable code designed to execute on the hardware interface to be designed and built concurrently, the time and costs associated with the design and build process of new devices are greatly reduced. Moreover, by allowing software testing to be done while the hardware interface is still be designed, the overall quality of the software is improved since the software is tailored to the most current version of the hardware interface, thereby reducing the need to refactor software based on revisions, edits, changes, modifications, and/or alterations to the design of the hardware interface.

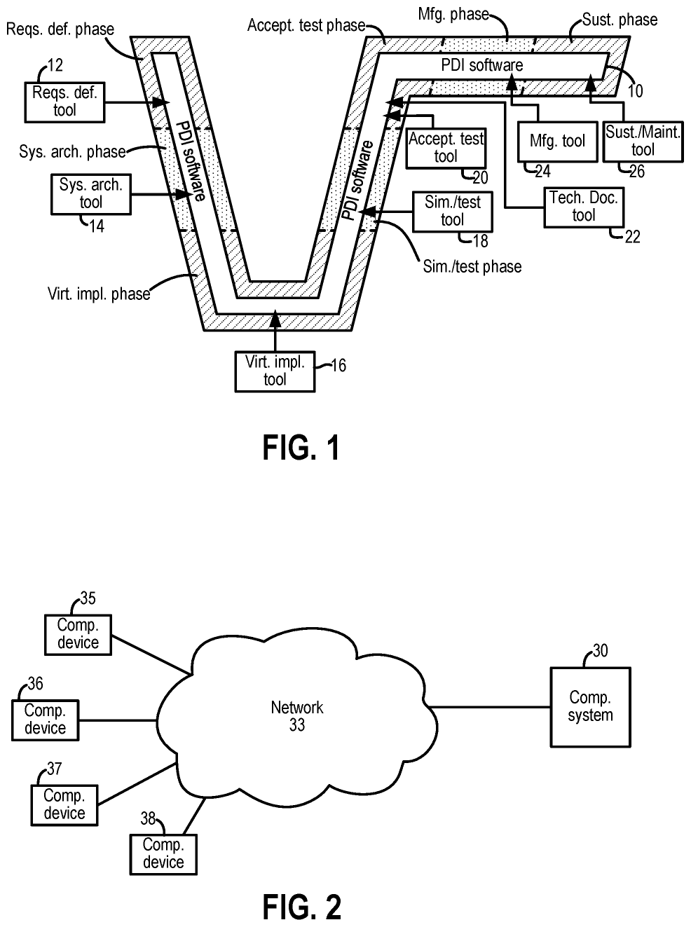

FIG. 1 shows an example of interactions of software and relationships of such software to engineering project phases in a digital engineering (DE) ecosystem. A DE ecosystem may be provided as a unified service to an enterprise, such as a corporation or other group that is performing an engineering design project. The DE ecosystem may comprise a product lifecycle management (PLM) tool, project data integration (PDI) software, and/or a plurality of engineering software tools. The DE ecosystem may be hosted on-premise, in the cloud, or provided as a hybrid solution. The DE ecosystem may further comprise a plurality of connectors, with each of the connectors corresponding to a different one of the engineering software tools and configured for generation of input data for the PLM tool based on output data from its corresponding software tool. Based on such input data, the PLM tool may generate project data, such as bills of material, that corresponds to at least a portion of the output data from the software tool, and that may be mapped or otherwise linked to other project data corresponding to output data from other software tools. Users associated with an enterprise may access the DE ecosystem via web browsers on conventional computing devices. At each stage of an engineering project, users may be able to access project data, created by the PLM tool and/or the PDI software, that may map and/or otherwise link data elements generated by the software tools. This may allow users working in later project phases to make design decisions based on reliable data from earlier phases. Moreover, providing the DE ecosystem to the enterprise as a service (e.g., software-as-a-server (SaaS)) facilitates simpler licensing of software.

As shown in FIG. 1, project phases are shown on a V diagram similar to other system engineering V diagrams. Overlaid on the V is PDI software 10. The PDI software 10 may comprise a single application, or may comprise a combination of applications (e.g., a commercially available application suite or other combination of interrelated applications). The PDI software 10, which may comprise the PLM tool and/or digital thread (DT) software, may integrate design data that is generated during each of the phases and make that integrated data available to determine links between design data elements corresponding to each of the phases. An example of software that may be used for the PDI software is the Aras Innovator® software provided by Aras Corporation of Andover, MA, US.

Requirements definition (reqs. def.) tool 12 may comprise a software tool that may interface (via a connector, not shown) with the PDI software 10. The software of the requirements definition tool 12 may comprise a single application, or may comprise a combination of applications (e.g., a commercially available application suite or other combination of interrelated applications). The requirements definition tool 12 may be used to define requirements for an engineering project and may output design data that comprises data elements describing those requirements. The requirements definition tool 12 may be software that is not an extension of, and is not native to, the PDI software 10, and/or that is not provided by the provider of the PDI software 10. An example of software that may be used for the requirements definition tool 12 is the IBM® Engineering Requirements Management DOORS® Next software provided by International Business Machines Corporation of Armonk, NY, US.

System architecture (sys. arch.) tool 14 may comprise a software tool that may interface (via a connector, not shown) with the PDI software 10. The software of the system architecture tool 14 may comprise a single application, or may comprise a combination of applications (e.g., a commercially available application suite or other combination of interrelated applications). The system architecture tool 14 may be used to define a system architecture for an engineering project and may output design data that comprises data elements describing that system architecture. The system architecture tool 14 may be software that is not an extension of, and is not native to, the PDI software 10, and/or that is not provided by the provider of the PDI software 10. Examples of software that may be used for the system architecture tool 14 are the CAMEO ENTERPRISE ARCHITECTURE software provided by Dassault Systèmes of Vélizy-villacoublay, FR and/or the IBM® Rational® Rhapsody® software provided by International Business Machines Corporation.

Virtual implementation (virt. impl.) tool 16 may comprise software that may interface (via a connector, not shown) with the PDI software 10. The software of the virtual implementation tool 16 may comprise a single application, or may comprise a combination of applications (e.g., a commercially available application suite or other combination of interrelated applications). The virtual implementation tool 16 may be used to create detailed virtual models of components and/or subsystems, and/or of an entire system. The virtual implementation tool 16 may output design data that comprises data elements describing those detailed virtual models. The virtual implementation tool 16 may be software that is not an extension of, and is not native to, the PDI software 10, and/or that is not provided by the provider of the PDI software 10. Example software that may be used for the virtual implementation tool 16 are the Solidworks® software provided by Dassault Systèmes SolidWorks Corporation of Waltham, MA, US and/or the NX software provided by Siemens Industry Software Inc. of Plano, TX, US.

As described in greater detail below, the virtual implementation tool 16 may also comprise first artificial intelligence configured to generate (e.g., create) one or more virtual hardware interfaces configured to emulate a hardware interface. The virtual implementation tool 16 may also comprise second artificial intelligence configured to generate one or more scripts configured to test the one or more virtual hardware interfaces to ensure that the one or more virtual hardware interfaces operating equivalently to their real-world counterpart. The first artificial intelligence and the second artificial intelligence may be additional software (e.g., a plug-in, an extension, etc.) created and added to the virtual implementation tool 16. The first artificial intelligence and the second artificial intelligence may comprise commercially-available artificial intelligence trained to perform the functions and/or processes described herein. Alternatively, the first artificial intelligence and the second artificial intelligence may comprise proprietary artificial intelligence built and trained to perform the functionality and processes described below.

Simulation/test (sim./test) tool 18 may comprise software that may interface (via a connector, not shown) with the PDI software 10. The software of the simulation/test tool 18 may comprise a single application, or may comprise a combination of applications (e.g., a commercially available application suite or other combination of interrelated applications). The simulation/test tool 18 may be used to simulate use of, and/or the effects of physical phenomena on, physical elements that are represented by virtual models of components and/or subsystems, and/or of an entire system. The simulation/test tool 18 may also or alternatively be used to conduct and/or document tests on physical elements. The simulation/test tool 18 may output design data that comprises data elements describing results of simulations and/or other virtual tests of modelled components, sub-systems or an entire system, as well as data elements describing actual tests. The simulation/test tool 18 may be software that is not an extension of, and is not native to, the PDI software 10, and/or that is not provided by the provider of the PDI software 10. Example software that may be used for the simulation/test tool 18 are the MATLAB® software provided by The MathWorks, Inc. of Natick, MA, US, the AGI STK software provided by Ansys, Inc. of Canonsburg, PA, US, the AGI Systems Tool Kit software provided by Ansys, Inc., the AFSIM (Advanced Framework for Simulation, Integration and Modeling) software provided by the United States government (the United States Air Force Research Laboratory), and/or the ModelCenter® software and the ModelCenter® MBSE software provided by Ansys, Inc.

As discussed in greater detail below, the simulation/test tool 18 may also execute code on the one or more virtual hardware interfaces. In particular, the simulation/test tool 18 may execute one or more scripts generated by the second artificial intelligence, discussed above, to test the one or more virtual hardware interfaces generated by the first artificial intelligence. Additionally or alternatively, the simulation/test tool 18 may also be configured to execute embedded software and/or executable code, created by a software development team, on the one or more virtual hardware interfaces, generated by the first artificial intelligence.

Acceptance testing (Accept. test) tool 20 may comprise a software tool that may interface (via a connector, not shown) with the PDI software 10. The software of the acceptance testing tool 20 may comprise a single application, or may comprise a combination of applications (e.g., a commercially available application suite or other combination of interrelated applications). The acceptance testing tool 20 may be used to generate documentation for acceptance testing and/or to track acceptance testing data, and may output design data that comprises data elements associated with acceptance testing. The acceptance testing tool 20 may be software that is not an extension of, and is not native to, the PDI software 10, and/or that is not provided by the provider of the PDI software 10.

Technical documentation (Tech. doc.) tool 22 may comprise a software tool that may interface (via a connector, not shown) with the PDI software 10. The software of the technical documentation tool 22 may comprise a single application, or may comprise a combination of applications (e.g., a commercially available application suite or other combination of interrelated applications). The technical documentation tool 22 may be used to generate manuals and/or other documentation to describe operation of, repair or, use of, and/or other characteristics of a system (or component thereof) that is designed using tools of the digital engineering ecosystem of FIG. 1, and may output design data that comprises data elements associated with such manuals and/or other technical documentation. The technical documentation tool 22 may be software that is not an extension of, and is not native to, the PDI software 10, and/or that is not provided by the provider of the PDI software 10.

Manufacturing tool (Mfg.) tool 24 may comprise a software tool that may interface (via a connector, not shown) with the PDI software 10. The software of the manufacturing tool 24 may comprise a single application, or may comprise a combination of applications (e.g., a commercially available application suite or other combination of interrelated applications). The manufacturing tool 24 may be used to generate and/or track data associated with manufacturing a system (or component thereof) that is designed using tools of the digital engineering ecosystem of FIG. 1, and may output design data that comprises data elements associated with such manufacturing. The manufacturing tool 24 may be software that is not an extension of, and is not native to, the PDI software 10, and/or that is not provided by the provider of the PDI software 10.

Sustainment/Maintenance tool (Sust./Maint.) tool 26 may comprise a software tool that may interface (via a connector, not shown) with the PDI software 10. The software of the sustainment/maintenance tool 26 may comprise a single application, or may comprise a combination of applications (e.g., a commercially available application suite or other combination of interrelated applications). The sustainment/maintenance tool 26 may be used to generate and/or track data associated with engineering changes and/or other modifications to a system (or component thereof) that is designed using tools of the digital engineering ecosystem of FIG. 1, and may output design data that comprises data elements associated with such changes and/or modifications. The sustainment/maintenance tool 26 may be software that is not an extension of, and is not native to, the PDI software 10, and/or that is not provided by the provider of the PDI software 10.

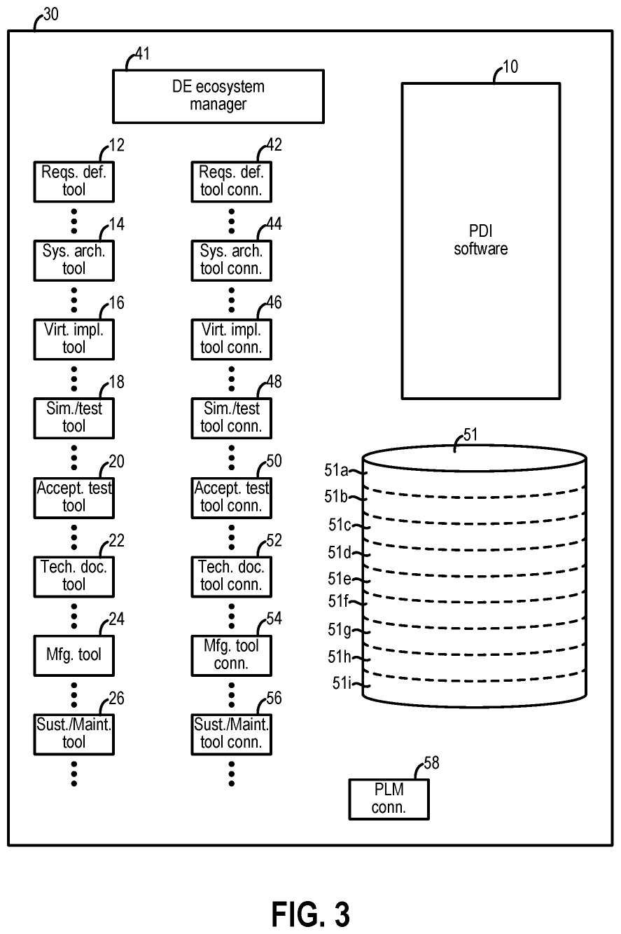

FIG. 2 shows an example network in which an example DE ecosystem may be implemented in accordance with one or more aspects of the disclosure. Software of a DE ecosystem may be hosted on, and be executed by, a computing system 30. As described in more detail in connection with FIG. 3 below, such software may comprise the PDI software 10, the tools 12, 14, 16, 18, 20, 22, 24, and 26, corresponding connectors, and additional software components. Although shown as a single block in FIG. 2 for convenience, the computing system 30 may comprise a single computing device or may comprise multiple computing devices. If implemented as multiple computing devices, the computing devices of the computing system 30 may communicate via one or more local or wide area networks (e.g., the network 33 described below), and may or may not be in close proximity of one another. Multiple computing devices of the computing system 30 may distribute computational tasks associated with the DE ecosystem software in any manner, and/or may host some or all of that software in one or more virtual servers. The computing system 30 may, for example, comprise computing devices associated with a cloud computing platform such as Amazon Web Services® cloud computing hosting services.

The computing system 30 may communicate, via one or more networks 33, with one or more computing devices such as the computing devices 35 through 38. Each of the computing devices 35 through 38, and/or other computing devices not shown in FIG. 2, may be associated with a user and may be used to access DE ecosystem software hosted on the computing system 30. Each of the computing devices 35 through 38, and/or other computing devices, may comprise a laptop computer, a desktop computer, and/or other type of computer comprising web browser software that may be used to access the DE ecosystem software. The network 33 may comprise the Internet and/or other wide area data network, a local area data network, or a combination of data networks.

FIG. 3 is a diagram showing example DE ecosystem software hosted on the computing system 30. The software may comprise the requirements definition tool 12, a requirements definition tool connector 42, the system architecture tool 14, a system architecture tool connector 44, the virtual implementation tool 16, a virtual implementation tool connector 46, the simulation/test tool 18, a simulation/test tool connector 48, the acceptance testing tool 20, an acceptance testing tool connector 50, the technical documentation tool 22, a technical documentation tool connector 52, the manufacturing tool 24, a manufacturing tool connector 54, the sustainment/maintenance tool 26, a sustainment/maintenance tool connector 56, a PLM connector 58, the PDI software 10, and a DE ecosystem manager 41.

As also shown in FIG. 3, the computing system 30 may comprise a database 51 having one or more portions used to store certain types of data. For example, a first portion 51a of the database 51 may be used to store requirements data for a project, such as data output by the requirements definition tool 12. A second portion 51b of the database 51 may be used to store system architecture data for a project, such as data output by the system architecture tool 14. A third portion 51c of the database 51 may be used to store virtual implementation data for a project, such as data output by the virtual implementation tool 16. A fourth portion 51d of the database 51 may be used to store simulation/test data for a project, such as data output by the simulation/test tool 18. A fifth portion 51e of the database 51 may be used to store acceptance testing data for a project, such as data output by the acceptance testing tool 20. A sixth portion 51f of the database 51 may be used to store technical documentation data for a project, such as data output by the technical documentation tool 22. A seventh portion 51g of the database 51 may be used to store manufacturing data for a project, such as data output by the manufacturing tool 24. An eighth portion 51h of the database 51 may be used to store sustainment/maintenance data for a project, such as data output by the sustainment/maintenance tool 26. A ninth portion 51i of the database 51 may be used to store project data output by the PDI software 10. That project data may correspond to, and may integrate, data output by the tools 12, 14, 16, 18, 20, 22, 24, and 26. For example, the project data may map (or otherwise link) data elements of data in one or more the database portions 51a through 51h with data elements of data in one or more other database portions 51a through 51h. Although a single database 51 is shown in FIG. 3 for simplicity, multiple databases (e.g., implemented by multiple computing devices of the computing system 30) may be used to store data such as that described herein.

The requirements definition tool connector 42 may receive data output by the requirements definition tool 12. That output data may comprise data elements, generated by the requirements definition tool 12 based on inputs from the users of the requirements definition tool 12, that make up requirements defined for a project. The project requirements may be stored in the database portion 51a, as indicated above. However, at least a portion of the output data from the requirements definition tool 12 may be used to generate project data output by the PDI software 10. In particular, the requirements definition tool connector 42 may receive data output by the requirements definition tool 12 and may process at least a portion of that data to generate input data for the PDI software 10. Based on that input data, which the PDI software 10 may receive from the connector 42, the PDI software 10 may generate project data and store that project data in the database portion 51i. The system architecture tool connector 44 may receive data output by the system architecture tool 14. That output data may comprise data elements, generated by the system architecture tool 14 based on inputs from the users of the system architecture tool 14, that make up a system architecture for the project. The project system architecture may be stored in the database portion 51b, as indicated above. However, at least a portion of the output data from the system architecture tool 14 may be used to generate project data output by the PDI software 10. In particular, the system architecture tool connector 44 may receive data output by the system architecture tool 14 and may process at least a portion of that data to generate input data for the PDI software 10. Based on that input data, which the PDI software 10 may receive from the connector 44, the PDI software 10 may generate project data and store that project data in the database portion 51i.

The virtual implementation tool connector 46 may receive data output by the virtual implementation tool 16. That output data may comprise data elements, generated by the virtual implementation tool 14 based on inputs from the users of the virtual implementation tool 16, that make up virtual models of components and/or subsystems (and/or the entire system) for the project. The virtual implementation data may be stored in the database portion 51c, as indicated above. However, at least a portion of the output data from the virtual implementation tool 16 may be used to generate project data output by the PDI software 10. In particular, the virtual implementation tool connector 46 may receive data output by the virtual implementation tool 16 and may process at least a portion of that data to generate input data for the PDI software 10. Based on that input data, which the PDI software 10 may receive from the connector 46, the PDI software 10 may generate project data and store that project data in the database portion 51i.

The simulation/test tool connector 48 may receive data output by the simulation/test tool 18. That output data may comprise data elements, generated by the simulation/test tool 18 based on inputs from the users of the simulation/test tool 18, that make up data for simulations performed on virtual models of components and/or subsystems (and/or the entire system) for the project and/or tests performed on physical elements. That simulation/test data may comprise results of the simulations and/or tests, configurations of simulations and/or tests (e.g., parameters and/or data models used), animations and/or other graphical or audio data generated during a simulation or test, and/or other types of data. The simulation/test data may be stored in the database portion 51d, as indicated above. However, at least a portion of the output data from the simulation/test tool 18 may be used to generate project data output by the PDI software 10. In particular, the simulation/test tool connector 48 may receive data output by the simulation/test tool 18 and may process at least a portion of that data to generate input data for the PDI software 10. Based on that input data, which the PDI software 10 may receive from the connector 48, the PDI software 10 may generate project data and store that project data in the database portion 51i.

The acceptance testing tool connector 50 may receive data output by the acceptance testing tool 20. That output data may comprise data elements, generated by the acceptance testing tool 20 based on inputs from the users of the acceptance testing tool 20, that make up acceptance testing data for a project. The acceptance testing data may be stored in the database portion 51e, as indicated above. However, at least a portion of the output data from the acceptance testing tool 20 may be used to generate project data output by the PDI software 10. In particular, the acceptance testing tool connector 50 may receive data output by the acceptance testing tool 20 and may process at least a portion of that data to generate input data for the PDI software 10. Based on that input data, which the PDI software 10 may receive from the connector 50, the PDI software 10 may generate project data and store that project data in the database portion 51i.

The technical documentation tool connector 52 may receive data output by the technical documentation tool 22. That output data may comprise data elements, generated by the technical documentation tool 22 based on inputs from the users of the technical documentation tool 22, that make up technical documentation data for a project. The technical documentation data may be stored in the database portion 51f, as indicated above. However, at least a portion of the output data from the technical documentation tool 22 may be used to generate project data output by the PDI software 10. In particular, the technical documentation tool connector 52 may receive data output by the technical documentation tool 22 and may process at least a portion of that data to generate input data for the PDI software 10. Based on that input data, which the PDI software 10 may receive from the connector 52, the PDI software 10 may generate project data and store that project data in the database portion 51i.

The manufacturing tool connector 54 may receive data output by the manufacturing tool 24. That output data may comprise data elements, generated by the manufacturing tool 24 based on inputs from the users of the manufacturing tool 24, that make up manufacturing data for a project. The manufacturing data may be stored in the database portion 51g, as indicated above. However, at least a portion of the output data from the manufacturing tool 24 may be used to generate project data output by the PDI software 10. In particular, the manufacturing tool connector 54 may receive data output by the manufacturing tool 24 and may process at least a portion of that data to generate input data for the PDI software 10. Based on that input data, which the PDI software 10 may receive from the connector 54, the PDI software 10 may generate project data and store that project data in the database portion 51i.

The sustainment/maintenance tool connector 56 may receive data output by the sustainment/maintenance tool 26. That output data may comprise data elements, generated by the sustainment/maintenance tool 26 based on inputs from the users of the sustainment/maintenance tool 26, that make up sustainment/maintenance data for a project. The sustainment/maintenance data may be stored in the database portion 51h, as indicated above. However, at least a portion of the output data from the sustainment/maintenance tool 26 may be used to generate project data output by the PDI software 10. In particular, the sustainment/maintenance tool connector 56 may receive data output by the sustainment/maintenance tool 26 and may process at least a portion of that data to generate input data for the PDI software 10. Based on that input data, which the PDI software 10 may receive from the connector 56, the PDI software 10 may generate project data and store that project data in the database portion 51i.

As indicated by the vertical ellipses under the requirements definition tool 12 and the requirements definition tool connector 42, the DE ecosystem may comprise more than one requirement definition software tool and corresponding connector. Similarly, and as shown by the other ellipses, the DE ecosystem may comprise more than one system architecture software tool and corresponding connector, more than one virtual implementation software tool and corresponding connector, more than one simulation/test software tool and corresponding connector, more than one acceptance testing software tool and corresponding connector, more than one technical documentation software tool and corresponding connector, more than one manufacturing software tool and corresponding connector, and/or more than one sustainment/maintenance software tool and corresponding connector. For example, the DE ecosystem may be configured to allow a group of users to select which tool of each type that the group prefers. In addition to the types of tools shown in FIG. 3, the DE ecosystem may also comprise other types of tools and corresponding connectors. For example, the DE ecosystem may comprise a PLM connector 58. The PLM connector 58 may interface the PDI software 10 and a separate (e.g., legacy) PLM system.

In addition to accessing the tools 12, 14, 16, 18, 20, 22, 24, and/or 26 (and/or other tools), users may also access the PDI software 10. For example, users may access the PDI software 10 to determine one or more requirements, generated using the requirements tool 12, related to data associated with one or more of the tools interfacing with the PDI software 10 (e.g., one or more portions of the system architecture, one or more virtual models, one or more simulations and/or tests, one or portions of acceptance testing data, one or more portion of technical documentation data, one or more portions of manufacturing data, one or more portions of sustainment/maintenance data, and/or to other types of data). In general, users may access the PDI software 10 to determine one or more portions of data, associated with any of the tools 12, 14, 16, 20, 22, 24, and/or 26 (and/or other tools), that may be related to any other data associated with any of the tools 12, 14, 16, 20, 22, 24, and/or 26 (and/or other tools).

The DE ecosystem manager 41 may comprise software to perform operations associated with providing users access to the DE ecosystem. For example, the DE ecosystem manager 41 may control login, verification and/or authentication of users, access control (e.g., limiting data available to specific users or groups of users), and other types of operations. The DE ecosystem manager 41 may monitor users' access (e.g., tools accessed, direct access of the PDI software 10, duration of login time or other temporal measure of access, amount of data transferred, etc.), and/or provide information from this monitoring for use in billing for access to the DE ecosystem. The DE ecosystem manager 41 may also or alternatively control instantiation of the DE ecosystem or portions thereof and/or access to an already-instantiated DE ecosystem or portions thereof. For example, the DE ecosystem manager 41 may comprise software configured to carry out operations such as those described below.

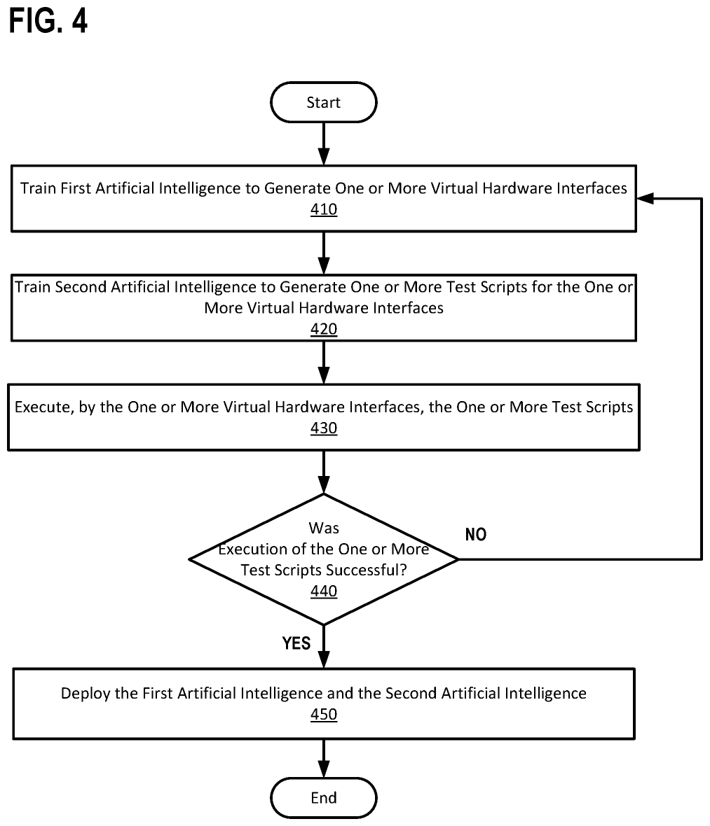

FIG. 4 shows an example of training artificial intelligence in accordance with one or more aspects of the disclosure. Some or all of the steps of the process shown in FIG. 4 may be performed using one or more computing devices as described herein.

In step 410, a computing device may train first artificial intelligence to generate one or more virtual hardware interfaces. The first artificial intelligence may comprise one or more machine learning models, such as a large language model (LLM). Additionally or alternatively, the first artificial intelligence may comprise a neural network, such as a convolutional neural network (CNN), a recurrent neural network, a recursive neural network, a long short-term memory (LSTM), a gated recurrent unit (GRU), an unsupervised pre-trained network, a space invariant artificial neural network, a generative adversarial network (GAN), or a consistent adversarial network (CAN), such as a cyclic generative adversarial network (C-GAN), a deep convolutional GAN (DC-GAN), GAN interpolation (GAN-INT), GAN-CLS, a cyclic-CAN (e.g., C-CAN), or any equivalent thereof. In some instances, the first artificial intelligence may comprise a generative artificial intelligence, such as ChatGPT, Bard, M365 Copilot, Scribe, Jasper, etc. Additionally or alternatively, the first artificial intelligence may comprise one or more decision trees. The first artificial intelligence may be trained using supervised learning, unsupervised learning, back propagation, transfer learning, Adam stochastic optimization, stochastic gradient descent, learning rate decay, dropout, max pooling, batch normalization, long short-term memory, skip-gram, or any equivalent deep learning technique. The first artificial intelligence may be trained, for example, using one or more of manually coded hardware interfaces, hardware specifications, technical data sheets, and the like. A corpus of the training data set may be divided into training data and testing data. Preferably, 65% to 85% of the corpus would form the training data, while the remaining 15% to 35% of the corpus would be test data. The first artificial intelligence may be trained using the training data, while the test data would be used to help the first artificial intelligence achieve convergence (i.e., an error range with an acceptable tolerance).

As part of the training of the first artificial intelligence, the training data may be inputted (e.g., entered) into the first artificial intelligence. First artificial intelligence may extract fixed hardware requirements and/or capabilities defined in the hardware specifications of the training data. For example, first artificial intelligence may extract a type of processor, a speed of the processor, built-in memory requirements of the processor, an amount of memory (e.g., RAM, ROM, storage (e.g., hard drives, steady state drives, etc.), etc.) of the hardware interface, a speed of the memory, a bus size, a bus speed, any specialized hardware components (e.g., one or more graphics processing units (GPUs), FPGAs, ASICs, antennas, etc.), and the like. Additionally or alternatively, first artificial intelligence may extract operating parameters, such as operating temperatures, voltages, etc. Based on the data extracted from the fixed hardware requirements and/or capabilities, the first artificial intelligence (e.g., a generator associated with the first artificial intelligence) may generate a virtual hardware interface. The first artificial intelligence (e.g., a discriminator associated with the first artificial intelligence) may compare the generated virtual hardware interface to a corresponding virtual hardware interface contained in the training data. When the generated virtual hardware interface matches the corresponding virtual hardware interface, the first artificial intelligence may be approaching convergence or achieving convergence. However, when the generated virtual hardware interface does not match the corresponding virtual hardware interface, first artificial intelligence may be trained or retrained. It will be appreciated that the comparison of generated virtual hardware interfaces to corresponding virtual hardware interfaces contained in training data may be an iterative approach until convergence is reached.

In step 420, the computing device may train second artificial intelligence to generate one or more scripts to test the one or more virtual hardware interfaces. The second artificial intelligence may be any of the types of artificial intelligence discussed above with respect to the first artificial intelligence. Similarly, the second artificial intelligence may be trained using any of the techniques described above with regard to the first artificial intelligence. The training data for the second artificial intelligence may comprise hardware specifications, technical data sheets, operating parameters, and the like.

As part of the training of the second artificial intelligence, the training data may be inputted (e.g., entered) into the second artificial intelligence. The training data for the second artificial intelligence may be based on operating parameters (e.g., operating temperatures, voltages, etc.). Second artificial intelligence may be trained to generate one or more scripts that ensure the virtual hardware interface performs within the operating parameters defined in the hardware specification. In this regard, the second artificial intelligence may be trained to generate executable code and/or embedded software designed to test the operating parameters of the virtual hardware interface. The training data may comprise examples of one or more test scripts that were used to test other virtual hardware interfaces. Second artificial intelligence may generate one or more scripts to run on a pre-existing virtual hardware interface, for example, based on the operating parameters for the pre-existing virtual hardware interface. If the pre-existing virtual hardware interfaces performs within its operating parameters while executing the one or more test scripts, the second artificial intelligence may be approaching, or achieving, convergence. However, if the pre-existing virtual hardware interfaces does not perform within its operating parameters while executing the one or more test scripts, the second artificial intelligence may be trained, or retrained. It will be appreciated that the generation of test scripts may be an iterative approach until convergence is reached.

After first artificial intelligence and second artificial intelligence have been trained, the computing device may request that the first artificial intelligence generate one or more virtual hardware interfaces, as part of the training and development process. Similarly, the second artificial intelligence may generate one or more scripts to test the functionality of the one or more virtual hardware interfaces generated by the first artificial intelligence. In step 430, the one or more virtual hardware interfaces may execute the one or more scripts. The one or more scripts may comprise one or more test scripts that are designed to ensure that virtual hardware interface performs within the hardware interface's operating parameters. For example, if the technical specification for the hardware interface indicates that one or more processors of the hardware interface would shut down if the operating temperature of the one or more processors exceeds 185° F., a first test script may cause the operating temperature of the one or more processors of the virtual hardware interface to exceed 185° F. The virtual hardware interface would pass the first test script, for example, if the virtual hardware interface shut down when the operating temperature exceeded 185° F. Conversely, the virtual hardware interface would fail the first test script if the one or more processor continued to operate when the operating temperature exceeded 185° F.

In step 440, the computing device may determine whether execution of the one or more scripts was successful. If the execution of the one or more scripts was not successful, the process may return to step 410, where the first artificial intelligence and/or the second artificial intelligence would be trained or retrained. If the execution of the one or more scripts was successful, then the first artificial intelligence and/or the second artificial intelligence may be deployed, in step 450. The computing device may deploy the first artificial intelligence and the second artificial intelligence, for example, as part of a DE ecosystems, virtual implementation tool 16, and/or simulation/test tool 18. The first artificial intelligence and the second artificial intelligence may be deployed, for example, based on the one or more virtual hardware interfaces performing in accordance with the operating parameters set forth in the technical documentation for the hardware interface.

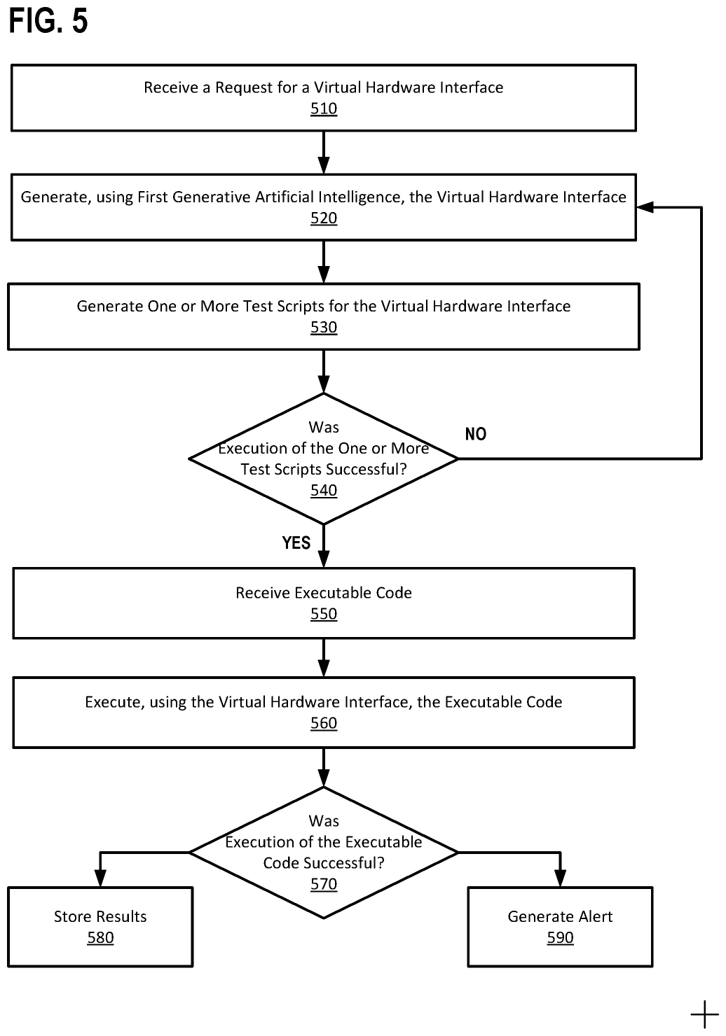

FIG. 5 shows an example of executing code on a virtual hardware interface in accordance with one or more aspects of the disclosure. Some or all of the steps of the process shown in FIG. 5 may be performed using one or more computing devices as described herein.

In step 510, a computing device may receive a request to generate a first virtual hardware interface. The first virtual hardware interface may be configured to emulate a hardware interface. The request to generate the first virtual hardware interface may comprise a hardware specification, technical documentation, a white paper, and the like for the hardware interface. Additionally or alternatively, the request to generate the first virtual hardware interface may comprise a code commit for the hardware interface. The code associated with the code commit may comprise a software stack configured to execute and/or control operation of the hardware interface.

In step 520, the computing device may generate the first virtual hardware interface. The first virtual hardware interface may be generated using the first artificial intelligence, discussed above. In this regard, the hardware specification, technical documentation, the white paper, and the like may be inputted into the first artificial intelligence. The first artificial intelligence may generate the first virtual hardware interface based on one or more operating parameters, inputs, outputs, etc. contained in the hardware specification, technical documentation, the white paper, and the like. In response to receiving the inputs, the first artificial intelligence may output the first virtual hardware interface. In some instances, the first artificial intelligence may integrate one or more hardware emulators into the first virtual hardware interface. The one or more hardware emulators may correspond to hardware components identified or contained in the hardware specification, technical documentation, the white paper, and the like. The first virtual hardware interface may be a digital twin of the hardware interface described in the hardware specification, technical documentation, the white paper, and the like. As used herein, a “digital twin” shall mean a virtual representation of an object or system (i.e., the hardware interface) that is designed to reflect the physical object accurately in both physical implementation and operation. The digital twin may be updated from real-time data and use simulation, machine learning, and/or reasoning to allow the digital twin to operate equivalently to its real-world counterpart.

In step 530, the computing device may generate one or more scripts to test the first virtual hardware interface. The one or more scripts may be generated using the second artificial intelligence. The one or more scripts may be similar to the scripts discussed above with respect to step 420 of FIG. 4. In this regard, the one or more scripts may be used to test the functionality of the first virtual hardware interface. The first virtual hardware interface may execute the one or more scripts to ensure that the first virtual hardware interface performs within the hardware interface's operating parameters. For example, if the technical specification for the hardware interface indicates that a hardware component will shut down if the voltage exceeds a threshold, a second test script may cause the voltage to exceed the threshold. The first virtual hardware interface would pass the second test script, for example, if the first virtual hardware interface shut down when the voltage exceeded the threshold. Conversely, the first virtual hardware interface would fail the second test script, for example, if the first virtual hardware interface continued to operate when the voltage exceeded the threshold.

In step 540, the computing device may determine whether the one or more scripts have been successfully executed by the first virtual hardware interface. A subset of the one or more scripts may be associated with relatively routine operations of the hardware interface. The subset of the one or more scripts may be the equivalent of “Hello, world” programs, to ensure that the first virtual hardware interface operates as it is supposed to. However, as discussed above, another subset of the one or more scripts may test the first virtual hardware interface to verify and/or validate that the first virtual hardware interface operates within its operating parameters and takes precautionary measures when the first virtual hardware interface goes beyond its operating parameters. If execution of the one or more scripts was unsuccessful, the process may return to step 520, where a new virtual hardware interface may be generated. The new virtual hardware interface may be generated using updated technical data and/or an updated (e.g., retrained) version of the first artificial intelligence. However, if execution of the one or more scripts was successful, the process may proceed to step 550.

In step 550, the computing device may receive executable code. The executable code may comprise embedded software. Additionally or alternatively, the executable code may comprise firmware, one or more applications, one or more applets, one or more scripts, one or more programs, etc. In some instances, the computing device may receive the executable code in response to detecting a code commit to a code repository. In this regard, the computing device may monitor one or more code repositories (e.g., GitHub). In response to detecting new code uploaded to the one or more code repositories, the computing device may request (e.g., query) the new code from the one or more code repositories. The computing device may receive the executable code in response to the request (e.g., query). In some instances, the executable code is being developed for the hardware interface at the same time that the hardware interface is being developed, built, manufactured, and/or assembled.

In step 560, the computing device (e.g., the computing device executing the first virtual hardware interface) may execute the executable code. In step 570, the computing device may determine whether the executable code was successfully executed by the first virtual hardware interface. The executable code may be considered to be executed successfully, for example, if no exceptions and/or errors are generated. Additionally or alternatively, the executable code may be considered to be executed successfully, for example, if the first virtual hardware interface operated within the operating parameters set forth in the hardware specification, technical documentation, the white paper, and the like. When the computing device determines that the executable code has been executed correctly, the computing device may store the results, in step 580. Storing the results may comprise logging successful execution of the executable code on the first virtual hardware interface.

However, when the computing device determines that the executable code did not executed correctly, the computing device may generate an alert, in step 590. The alert may comprise one or more indications of an error. A first indication of an error may identify an error with the executable code. A second indication of an error may indicate a hardware error. Based on the type of error indicated, a ticket may be created to address the error. For example, the first indication of an error may cause a first ticket to be generated for the software development team to address the issues that generated the error. Alternatively, the second indication of error may cause a second ticket to be generated for the hardware development team. In this way, the first virtual hardware interface may identify the source of errors and notify appropriate teams of the issue(s).

A hardware error may cause changes to the hardware specification, technical documentation, the white paper, and the like. Changes to the hardware specification, technical documentation, the white paper, and the like may cause the computing device to generate a second virtual hardware interface, for example, using the first generative artificial intelligence and based on the indicated hardware error. The second virtual hardware interface may comprise an updated version of the hardware interface. After the second virtual hardware interface is generated, similar processes to those described may be executed. By using virtual hardware interfaces, software and hardware development is allowed to happen concurrently. This reduces the time spent on engineering new hardware and its corresponding software. Moreover, the concurrent approach described herein helps identify and resolve both hardware and software issues quicker. Ultimately, more stable and secure products are produced in a shorter timeline.

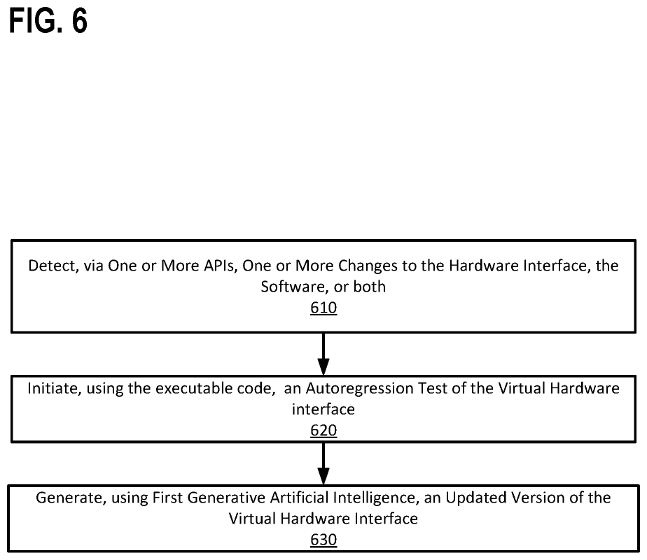

FIG. 6 shows an example of updating the virtual hardware interface in accordance with one or more aspects of the disclosure. Some or all of the steps of the process shown in FIG. 6 may be performed using one or more computing devices as described herein.

In step 610, a computing device may detect, via one or more application programming interfaces (APIs), one or more changes to the hardware interface, the software, or both. Changes to the hardware interface may be identified by changes to the hardware specification, technical documentation, the white paper, and the like. In this regard, the one or more first APIs may monitor and/or detect changes to the hardware specification, technical documentation, the white paper, and the like. Changes to the software may be identified by changes, updates, modifications, and/or alterations made to the code. Similar to detecting changes to the hardware interface, one or more second APIs may monitor a code repository to detect code commits and/or other changes to the software and/or executable code. In response to detecting changes to the hardware interface, the software, or both, the computing device may initiate an autoregression test of the executable code, in step 620. Based on the autoregression test and using the first generative artificial intelligence, the computing device may generate a second virtual hardware interface that is an updated version of the first hardware interface, in step 630. This allows the computing device to ensure that the executable code is up-to-date and capable of running on the latest iteration of the virtual hardware interface.

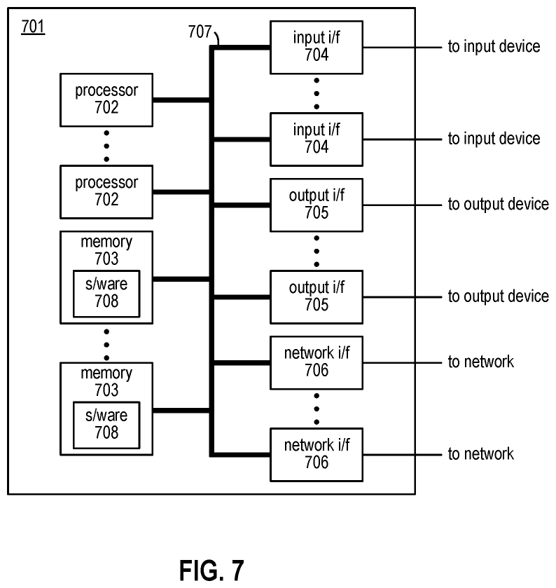

FIG. 7 is a block diagram of an example computing device 701, one or more of which may be used to implement the computing system 30, any of the computing devices 35 through 38, and/or other computing device(s) and to perform operations such as those described herein. Computing device 701 may comprise one or more processors 702, one or more memories 703, one or more input interface controllers 704, one or more output interface controllers 705, and one or more network interfaces 706, all of which may communicate over one or more busses 707. Processor(s) 702 may include any of various types of computational devices such as, without limitation, programmable microprocessors. Processor(s) 702 may execute instructions that cause computing device 701 to perform one or more operations such as are described herein. Memory(ies) 703 may include any of various types of non-transitory machine-readable storage media such as, without limitation, random access memory (RAM), read-only memory (ROM), FLASH memory, magnetic tape or discs, optical discs, etc. Memory(ies) 703 may be volatile or non-volatile. Input interface controller(s) 704 may include hardware and/or software that allow user input devices (e.g., a keyboard, a mouse, a touch screen) to communicate data to processor(s) 702. Output interface controller(s) 705 may include hardware and/or software that allow user output devices (e.g., display screens, printers) to output user understandable information based on data from processor(s) 702. Network interface(s) 706 may include hardware and/or software that allow processor(s) 702 to communicate with processors of other computers via one or more types of wired or wireless networks. Examples of network interfaces include, without limitation, Ethernet adaptors and Wi-Fi adaptors (e.g., operating in accordance with one or more IEEE 802.11 WLAN standards).

Memory(ies) 703 may store software 708 that provides instructions to processor(s) 702 that, when executed by processor(s) 702, cause computer 701 to perform some or all operations such as are described herein. Software 708 may comprise machine-executable instructions and/or other data, and may include both application software and operating system software. Executable instructions that cause computer 701 to perform operations such as are described herein may also or alternatively be stored in other forms, e.g., as firmware or as hardware logic in an integrated circuit.

Using the techniques described above, the present disclosure allows for the artificial intelligence to develop hardware and software concurrently. This reduces the time spent on engineering new hardware and its corresponding software. Moreover, the concurrent approach described herein helps identify and resolve both hardware and software issues quicker. Ultimately, more stable and secure products are produced in a shorter timeline, thereby improving the digital engineering ecosystem.

One or more features discussed herein may be embodied in computer-usable or readable data and/or computer-executable instructions, such as in one or more program modules, executed by one or more computers or other devices as described herein. Program modules may comprise routines, programs, objects, components, data structures, and the like, that perform particular tasks or implement particular abstract data types when executed by a processor in a computer or other device. The modules may be written in a source code programming language that is subsequently compiled for execution, or may be written in a scripting language such as (but not limited to) Java or Python. The computer executable instructions may be stored on a computer readable medium such as a hard disk, optical disk, removable storage media, solid-state memory, RAM, and the like. The functionality of the program modules may be combined or distributed as desired. In addition, the functionality may be embodied in whole or in part in firmware or hardware equivalents such as integrated circuits, field programmable gate arrays (FPGA), and the like. Particular data structures may be used to more effectively implement one or more features discussed herein, and such data structures are contemplated within the scope of computer executable instructions and computer-usable data described herein. Various features described herein may be embodied as a method, a computing device, a system, and/or a computer program product.

Although the present disclosure has been described in terms of various examples, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present disclosure may be practiced otherwise than specifically described without departing from the scope and spirit of the present disclosure. Although examples are described above, features and/or steps of those examples may be combined, divided, omitted, rearranged, revised, and/or augmented in any desired manner. Thus, the present disclosure should be considered in all respects as illustrative and not restrictive. Accordingly, the scope of the disclosure should be determined not by the examples, but by the appended claims and their equivalents.

What is claimed is:

1. A computer-implemented method comprising:
receiving, by a computing device, a request to generate a first virtual hardware interface;
generating, by the computing device and using a first generative artificial intelligence, the first virtual hardware interface, wherein the first virtual hardware interface is configured to emulate a hardware interface;
generating, by the computing device and using a second generative artificial intelligence, one or more scripts to test the first virtual hardware interface;
determining, by the computing device, whether the one or more scripts have been successfully executed by the first virtual hardware interface;
receiving, by the computing device and based on a determination that the one or more scripts have been successfully executed by the first virtual hardware interface, executable code, wherein the executable code is configured to execute on the hardware interface;
executing, by the first virtual hardware interface, the executable code;
determining, by the computing device, whether the executable code has been successfully executed by the first virtual hardware interface; and
logging, based on a determination that the executable code has been successfully executed by the first virtual hardware interface, successful execution of the executable code on the first virtual hardware interface.

2. The computer-implemented method of claim 1, further comprising:
receiving, by the computing device, second executable code;
executing, by the first virtual hardware interface, the second executable code;
determining, by the computing device, whether the second executable code has been successfully executed by the first virtual hardware interface; and
generating, based on a determination that the second executable code has not been successfully executed by the first virtual hardware interface, an alert.

3. The computer-implemented method of claim 2, wherein the alert comprises at least one of:
an indication of an error with the second executable code; or
an indication of a hardware error.

4. The computer-implemented method of claim 3, further comprising:
generating, using the first generative artificial intelligence and based on the indication of the hardware error, a second virtual hardware interface, wherein the second virtual hardware interface comprises an updated version of the hardware interface.

5. The computer-implemented method of claim 4, further comprising:
training the first generative artificial intelligence to generate virtual hardware interfaces; and
training the second generative artificial intelligence to generate scripts to test virtual hardware interfaces generated by the first generative artificial intelligence.

6. The computer-implemented method of claim 1, wherein the request to generate the first virtual hardware interface comprises at least one of:
a hardware specification for the hardware interface; or
a code commit for a software stack associated with the hardware interface.

7. The computer-implemented method of claim 1, further comprising:
detecting, by the computing device, one or more changes to the hardware interface;
initiating, by the computing device, an autoregression test of the executable code; and
generating, using the first generative artificial intelligence and based on the autoregression test, a second virtual hardware interface, wherein the second virtual hardware interface comprises an updated version of the hardware interface.

8. The computer-implemented method of claim 1, wherein the executable code comprises embedded software.

9. The computer-implemented method of claim 1, further comprising:
generating, using the first generative artificial intelligence, a second virtual hardware interface, wherein the second virtual hardware interface comprises an updated version of the hardware interface;
generating, by the computing device and using the second generative artificial intelligence, one or more second scripts to test the second virtual hardware interface;
determining, by the computing device, whether the one or more second scripts have been successfully executed by the second virtual hardware interface; and
generating, using the first generative artificial intelligence and based on a determination that the one or more second scripts have not been successfully executed by the second virtual hardware interface, a third virtual hardware interface.

10. The computer-implemented method of claim 1, further comprises:
integrating, prior to determining whether the one or more scripts have been successfully executed by the first virtual hardware interface, one or more hardware emulators into the first virtual hardware interface.

11. A computing device comprising:
one or more processors; and
memory storing instructions that, when executed by the one or more processors, cause the computing device to:
receive a request to generate a first virtual hardware interface;
generate, using a first generative artificial intelligence, the first virtual hardware interface, wherein the first virtual hardware interface is configured to emulate a hardware interface;
generate, using a second generative artificial intelligence, one or more scripts for the first virtual hardware interface;
determine whether the one or more scripts have been successfully executed by the first virtual hardware interface;
receive, based on a determination that the one or more scripts have been successfully executed by the first virtual hardware interface, executable code, wherein the executable code is configured to execute on the hardware interface;
execute, by the first virtual hardware interface, the executable code;
determine whether the executable code has been successfully executed by the first virtual hardware interface; and
log, based on a determination that the executable code has been successfully executed by the first virtual hardware interface, successful execution of the executable code on the first virtual hardware interface.

12. The computing device of claim 11, wherein the instructions, when executed by the one or more processors, cause the computing device to:
receive second executable code;
execute, by the first virtual hardware interface, the second executable code;
determine whether the second executable code has been successfully executed by the first virtual hardware interface; and
generate, based on a determination that the second executable code has not been successfully executed by the first virtual hardware interface, an alert, wherein the alert comprises at least one of:
an indication of an error with the second executable code; or
an indication of a hardware error.

13. The computing device of claim 11, wherein the instructions, when executed by the one or more processors, cause the computing device to:
train the first generative artificial intelligence to generate one or more virtual hardware interfaces.

14. The computing device of claim 11, wherein the instructions, when executed by the one or more processors, cause the computing device to:
train the second generative artificial intelligence to generate scripts to test one or more virtual hardware interfaces.

15. The computing device of claim 11, wherein the one or more scripts are configured to test one or more operating conditions of the hardware interface.

16. The computing device of claim 11, wherein the instructions, when executed by the one or more processors, cause the computing device to:
detect, via an application programming interface (API), one or more changes to the hardware interface;
initiate an autoregression test of the executable code; and
generate, using the first generative artificial intelligence and based on the autoregression test, a second virtual hardware interface, wherein the second virtual hardware interface comprises an updated version of the hardware interface.

17. One or more non-transitory computer-readable media comprising instructions that, when executed, configure a computing device to:
receive a request to generate a first virtual hardware interface;
generate, using a first generative artificial intelligence, the first virtual hardware interface, wherein the first virtual hardware interface is configured to emulate a hardware interface;
generate, using a second generative artificial intelligence, one or more scripts for the first virtual hardware interface;
determine whether the one or more scripts have been successfully executed by the first virtual hardware interface;
receive, based on a determination that the one or more scripts have been successfully executed by the first virtual hardware interface, executable code, wherein the executable code is configured to execute on the hardware interface;
execute, by the first virtual hardware interface, the executable code;
determine whether the executable code has been successfully executed by the first virtual hardware interface; and
log, based on a determination that the executable code has been successfully executed by the first virtual hardware interface, successful execution of the executable code on the first virtual hardware interface.

18. The one or more non-transitory computer-readable media of claim 17, wherein the instructions, when executed, configure a computing device to:
detect one or more changes to the hardware interface;
initiate an autoregression test of the executable code; and
generate, using the first generative artificial intelligence and based on the autoregression test, a second virtual hardware interface, wherein the second virtual hardware interface comprises an updated version of the hardware interface.

19. The one or more non-transitory computer-readable media of claim 17, wherein the instructions, when executed, configure a computing device to:
train the first generative artificial intelligence to generate one or more virtual hardware interfaces; and
train the second generative artificial intelligence to generate scripts to test one or more virtual hardware interfaces.

20. The one or more non-transitory computer-readable media of claim 17, wherein the instructions, when executed, configure a computing device to:
integrate, prior to determining whether the one or more scripts have been successfully executed by the first virtual hardware interface, one or more hardware emulators into the first virtual hardware interface.
